(19) United States
(12) Patent Application Publication
(10) Pub. No.: US 2020/0127485 A1
(43) Pub. Date: Apr. 23, 2020

(54) SELF-PROPELLED POWER STATION

(71) Applicant: Timothy J. FRIESEN, Edmonton (CA)

(72) Inventor: Timothy J. FRIESEN, Edmonton (CA)

(21) Appl. No.: 16/595,756

(22) Filed: Oct. 8, 2019

(30) Foreign Application Priority Data
Oct. 17, 2018 (CA) 3 021 183

(51) Int. Cl. H02J 7/14; H02J 7/02; H02J 7/00; H02J 7/35; H02S 10/40

(52) U.S. Cl. CPC H02J 7/1415; H02J 7/022; H02J 2003/388; H02J 7/35; H02S 10/40; H02J 7/0065

(57) ABSTRACT

A self-propelled power station has a frame with a platform. The frame is supported by wheels and is steerable through the use of a handle. At least one battery is positioned on the platform. The batteries provide power to a power inverter that has an AC socket. A solar panel is provided for charging the batteries. The solar panel has a charge controller for controlling the flow of electricity from the solar panel to the batteries. A motor powered by the batteries is used to drive at least one wheel of self-propelled power station.

### FIELD OF THE DISCLOSURE

The present application relates generally to mobile power station and more specifically to a self-propelled power station with solar panels.

### BACKGROUND

This section provides background information to facilitate a better understanding of the various aspects of the invention. It should be understood that the statements in this section of this document are to be read in this light, and not as admissions of prior art.

When working on projects at a work site, easy access to electricity can be a problem. Often, large generators must be placed on site to provide access to power. These generators may provide electricity in one location, leaving other parts of the work site without electricity. While these generators may be moved, this requires the use of a truck or heavy machinery. Having a power source that is mobile which may provide access to electricity anywhere on a work site would be beneficial.

### BRIEF SUMMARY

There is provided a self-propelled power station. The self-propelled power station has a frame with a platform. The frame is supported by wheels and is steerable with a handle. At least one battery is positioned on the platform. The at least one battery is provides power to a power inverter that has an AC socket. A solar panel is removably attachable to the self-propelled power station. The solar panel charges the at least one battery. A charge controller is provided for controlling the flow of electricity from the solar panel to the at least one battery. A motor that is powered by the at least one battery is provided for driving at least one wheel.

In one embodiment, a generator is provided on the platform in connection with the at least one battery for charging the at least one battery. This allows self-propelled power station to provide electricity when there is insufficient electricity being produced by the solar panels and battery. Generator may be a gas generator, a diesel generator or any other type of generator known by a person skilled in the art.

In one embodiment, an AC adaptor plug is provided in connection with the at least one battery for charging the at least one battery. This allows self-propelled power station to be plugged into an AC socket when electricity is available on a work site.

In one embodiment, the at least one battery has a voltage meter to measure voltage in the battery. This allows the user to monitor the voltage within the batteries to determine when the batteries need to be recharged.

In one embodiment, each of the wheels supporting the frame may be driven by independent electric motors. It will also be understood that one motor can be used to drive two wheels, two motors can be used to drive four wheels or any other combination of wheels and electric motors may be used.

In one embodiment, eight batteries are provided to power the electric motors and provide electricity to the power inverter. It will be understood that more or fewer batteries may be used.

In one embodiment, two solar panels are provided for collecting solar energy.

In one embodiment, removable panels are provided for enclosing the frame. The removable panels protect the parts of the self-propelled power station from damage, dust and debris during use and storage. Batteries, inverters and motors may be protected within the removable panels.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a perspective view of a self-propelled power station.

FIG. 2 is an exploded view of the self-propelled power station shown in FIG. 1

FIG. 3A is a schematic view of electrical connections within the self-propelled power station.

FIG. 3B is a schematic view of additional electrical connections within the self-propelled power station.

FIG. 3C is a schematic view of a variation of electrical connections within the self-propelled power station.

FIG. 3D is a schematic view of the electrical connections for the solar panel used with the self-propelled power station.

### DETAILED DESCRIPTION OF THE PREFERRED EMBODIMENTS

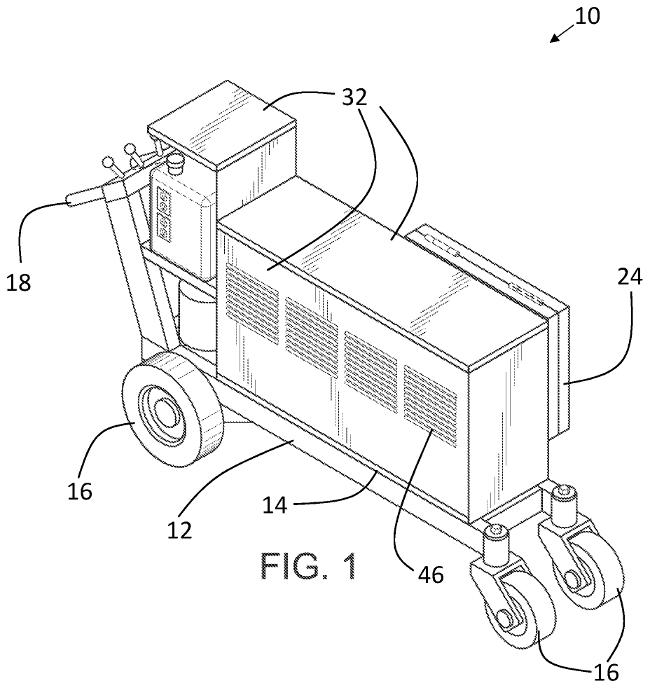

A self-propelled power station, generally identified by reference numeral 10, will now be described with reference to FIG. 1 through FIG. 3D.

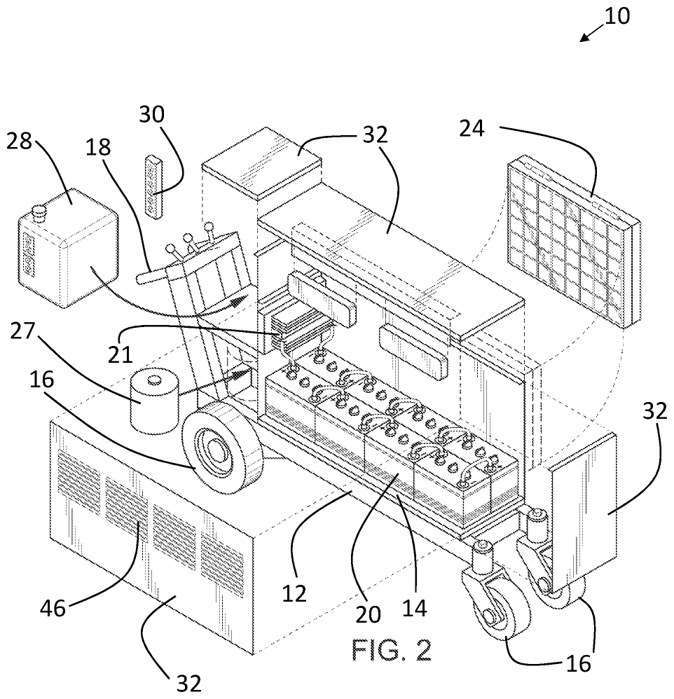

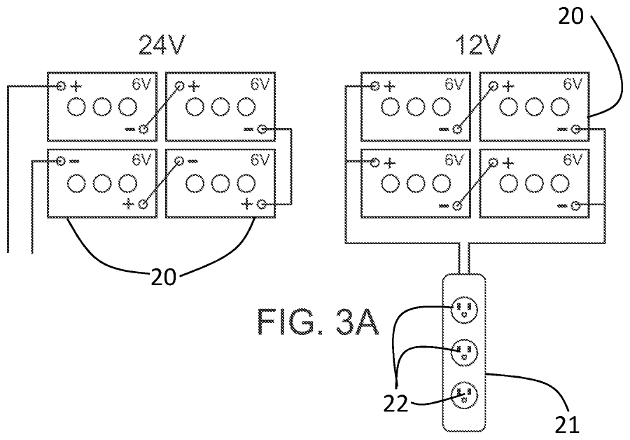

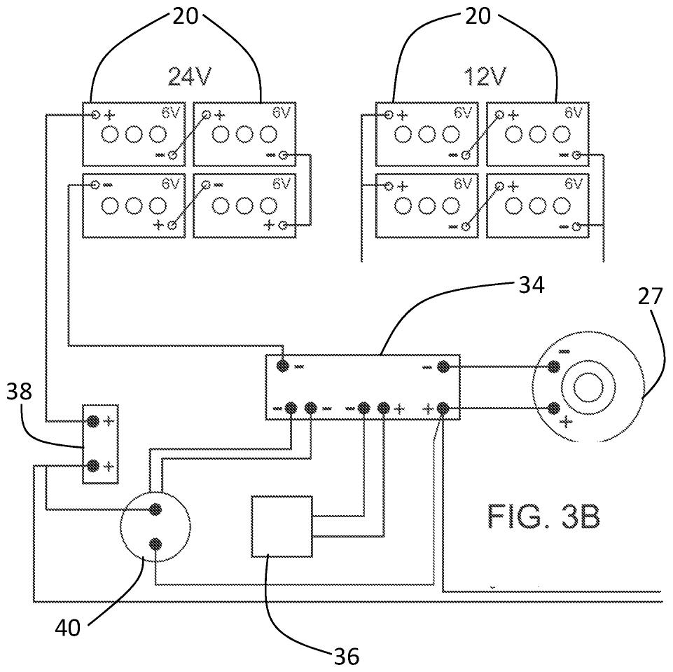

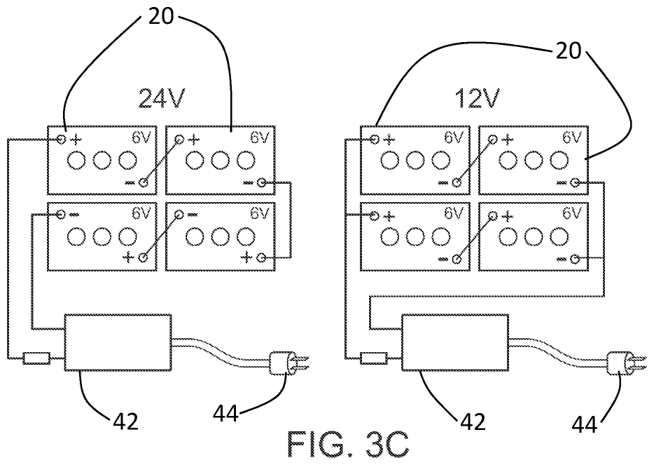

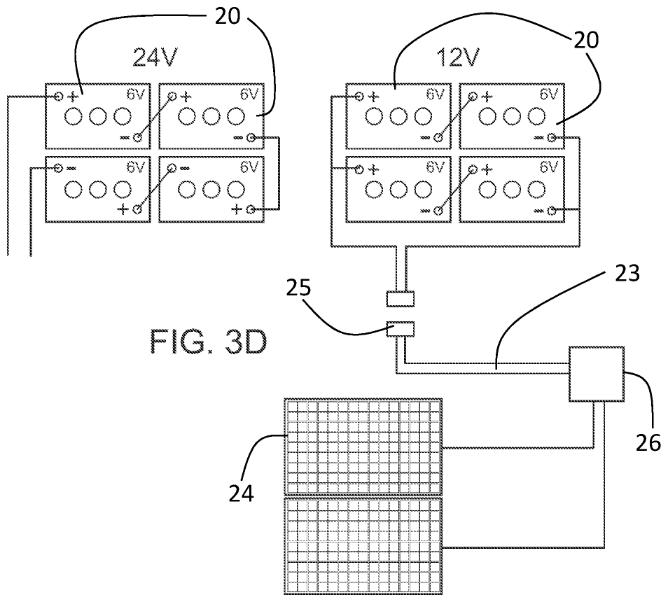

Referring to FIG. 1, self-propelled power station 10 has a frame 12 with a platform 14. Frame 12 is supported by wheels 16 and a handle 18 is provided for steering. In the embodiment shown, handle 18 is attached to frame 12, however it will be understood that handle may be attached to platform 14 or wheels 16. Referring to FIG. 2, batteries 20 are positioned on platform 14 and provide energy to a power inverter 21. In the embodiment shown, there are eight batteries 20. It will be understood that any number of batteries 20 may be used. Referring to FIG. 3A, power inverter 21 has AC sockets 22 that are used to provide electricity to tools and other items needing electricity.

Referring to FIG. 1 and FIG. 2, a solar panel 24 is removably attachable to power station 10 for charging batteries 20. In the embodiment shown, two solar panels 24 are shown, however it will be understood that a single solar panel 24 or more than two solar panels 24 may be used. It is preferable that solar panels 24 be removably attached to power station 10 to allow solar panels 24 to be set up at a distance from power station 10. Solar panels 24 may be placed on a stand or free standing. Referring to FIG. 3D, solar panels 24 are attached to batteries 20 with a cable 23 having a connector end 25. It is will be understood that cable 23 may be different lengths or interchanged to allow for solar panels 24 to be placed at varying distances from power station 10. Solar panel 24 has a charge controller 26 for controlling the flow of electricity from solar panel 24 to batteries 20. In one embodiment,not shown, handle 18 of self-propelled power station 10 is used to support solar panels 24. Handle 18 may be adjustable to allow the angle of solar panels 24 to be changed when supported on handle 18. In one embodiment, the positioning of solar panel 24 is adjustable on self-propelled power station 10 so that the angle of solar panel 24 may be altered to better track the sun.

Referring to FIG. 3C, batteries 20 may be charged through the use of A/C power when available. Batteries 20 may be connected to an A/C adapter 42. A/C adapter 42 has a power plug 44 that can be plugged into a plug. When electricity is available on a worksite, it is beneficial to have an AC adaptor 42 and plug 44 provided in connection with batteries 20.

Referring to FIG. 3, a motor 27 is provided for driving at least one of wheels 16 to allow for movement of self-propelled power station 10. Motor 27 is powered by batteries 20. Motor 27 is connected to a motor controller 34 which, in turn, is connected to batteries 20 and a controller 36. Batteries 20 provide power to motor 27 while controller 36 controls the motor 27. Controller 36 may be used to start or stop motor 27 by controlling the flow of power from batteries 20 or control which direction motor runs. Controller 36 may also be used to control directional movements of self-propelled power station 10. A fuse 38 may be provided as a safety feature to prevent overheating of the circuit. A coil 40, may also be provided within the circuit.

Each of wheels 16 supporting frame 12 may be driven by independent electric motors 27. It will also be understood that one motor 27 can be used to drive two wheels 16, two motors 27 can be used to drive four wheels 16 or any other combination of wheels 16 and electric motors 27 may be used. Electric motors 27 draw electricity from batteries 20 during operation.

By providing a generator 28 on platform 14 in connection to batteries 20 for charging batteries 20, power station 10 may be used when the collection of solar power is not an option. In the embodiment shown, generator 28 is a gas generator. A person of skill will understand that generator 28 may be a diesel generator, a natural gas generator or any other acceptable generator known in the art.

A voltage meter, not shown, may be positioned on batteries 20 to provide users with a visual representation of battery life. This will allow users to determine when batteries 20 require recharging.

Removable panels 32 provide protection to the parts of self-propelled power station 10 positioned on platform 14. This helps to protect electrical connections between batteries 20, motor 27, inverter 21 and any other part used in power station 10. The removable panels protect the parts of the self-propelled power station from damage, dust and debris during use and storage. Batteries, inverters and motors may be protected within the removable panels. Access to these parts is available by removing removable panels 32 for diagnosis of problems or the replacement of batteries 20 as needed. As can be seen in the embodiment shown, removable panels 32 may have vents 46 to allow for the flow of air through removable panels 32 to help prevent overheating of self-propelled power station 10.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A self-propelled power station, comprising:
a frame having a platform, the frame being supported by wheels and being steerable by a handle;
at least one battery positioned on the platform, the at least one battery providing power to a power inverter, the power inverter having an AC socket;
a solar panel removably attachable to the self-propelled power station for charging the at least one battery, the solar panel having a charge controller for controlling the flow of electricity from the solar panel to the at least one battery; and
a motor powered by the at least one battery for driving at least one wheel.

2. The self-propelled power station of claim 1 wherein a generator is provided on the platform in connection to the at least one battery for charging the at least one battery.

3. The self-propelled power station of claim 2 wherein the generator is a gas generator.

4. The self-propelled power station of claim 1 wherein a power plug is provided in connection with the at least one battery for charging the at least one battery.

5. The self-propelled power station of claim 1 wherein the at least one battery has a voltage meter.

6. The self-propelled power station of claim 1 wherein each of the wheels supporting the frame is driven by an independent electric motor.

7. The self-propelled power station of claim 1 wherein there are eight batteries.

8. The self-propelled power station of claim 1 wherein there are two solar panels.

9. The self-propelled power station of claim 1 further comprising removable panels for enclosing the frame.
